(19) United States
(12) Patent Application Publication
(10) Pub. No.: US 2025/0370952 A1
(43) Pub. Date: Dec. 4, 2025

(54) COMMUNICATING MANAGEMENT MESSAGES ENCAPSULATED IN DATA OBJECT EXCHANGE DATA OBJECTS

(71) Applicant: Micron Technology, Inc., Boise, ID (US)

(72) Inventors: Rohit K. SINDHU, San Jose, CA (US); Rohit SEHGAL, San Jose, CA (US); Vishal TANNA, Santa Clara, CA (US)

(21) Appl. No.: 19/170,661

(22) Filed: Apr. 4, 2025

Related U.S. Application Data
(60) Provisional application No. 63/653,462, filed on May 30, 2024.

(51) Int. Cl. G06F 13/42

(52) U.S. Cl. CPC G06F 13/4282; G06F 2213/0026

(57) ABSTRACT

In some implementations, a device may receive, from a host device, a plurality of first data words of a request data object exchange (DOE) data object that encapsulates a request management message of a hardware device management protocol, where each data word of the plurality of first data words corresponds to a portion of the request management message. The device may construct the request management message using the plurality of first data words. The device may transmit a plurality of second data words of a response DOE data object that encapsulates a response management message of the hardware device management protocol, where each data word of the plurality of second data words corresponds to a portion of the response management message.

### CROSS-REFERENCE TO RELATED APPLICATION

This Patent application claims priority to U.S. Provisional Patent Application No. 63/653,462, filed on May 30, 2024, entitled “COMMUNICATING MANAGEMENT MESSAGES ENCAPSULATED IN DATA OBJECT EXCHANGE DATA OBJECTS,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to communicating management messages encapsulated in data object exchange data objects.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

The peripheral component interconnect (PCI) protocol is a protocol for input/output (I/O) communication via a PCI bus, which may be implemented on a motherboard of a computer. The PCI bus supports the functions found on a processor bus but in a standardized format that is independent of any particular processor's native bus. The PCI protocol has evolved into the PCI express (PCIe) protocol, which provides benefits such as a higher throughput, reduced pin count, and better performance scaling in comparison to legacy PCI.

### BRIEF DESCRIPTION OF THE DRAWINGS

FIG. 1 is a diagram illustrating an example system capable of communicating management messages encapsulated in data object exchange (DOE) data objects.

FIG. 2 is a diagram illustrating an example PCI-vendor-defined message (VDM) packet.

FIG. 3 is a diagram illustrating an example of encapsulating a management message in a DOE data object.

FIG. 4 is a diagram illustrating an example of communicating management messages encapsulated in DOE data objects.

FIG. 5 is a diagram illustrating an example of communicating management messages encapsulated in DOE data objects.

FIG. 6 is a diagram of an example of communicating management messages encapsulated in DOE data objects.

FIG. 7 is a diagram of an example of communicating management messages encapsulated in DOE data objects.

FIG. 8 is a flowchart of an example method associated with communicating management messages encapsulated in DOE data objects.

FIG. 9 is a flowchart of an example method associated with communicating management messages encapsulated in DOE data objects.

### DETAILED DESCRIPTION

The communication between components of a computing system over various protocols facilitates effective system management. One such communication medium is the PCIe interface, which is used for high-speed data transfer between system components. Management component transport protocol (MCTP) is a protocol that devices use for management purposes, including firmware updates, sensor information retrieval, and other management operations. For example, MCTP is a message-based protocol used to manage components within platforms. MCTP requires an underlying physical medium to communicate, typically employing methods such as MCTP over PCI vendor defined messages (VDM).

However, employing MCTP over in-band PCIe (e.g., using a PCIe physical layer) using traditional PCI-VDM presents challenges. For example, employing MCTP over in-band PCIe relies on devices with the capability to generate MCTP packets, and such capabilities are not standard in all devices. As a workaround, systems may employ additional specialized hardware capable of generating MCTP packets, or MCTP capability may be embedded in additional application-specific integrated circuits (ASICs) or field-programmable gate arrays (FPGAs). However, these workarounds impose significant additional cost and complexity. As a result, many systems, particularly those that do not have embedded management controllers such as baseboard management controls (BMCs) and/or do not have access to PCIe interposer hardware (e.g., that use PCIe exerciser units), are limited in their capability to issue MCTP commands for device management.

Some implementations described herein enable exchanging management messages (e.g., MCTP packets) over a PCIe interface by encapsulating the messages within data object exchange (DOE) data objects. For example, a host device and/or a peripheral device that has a management message to transmit may encapsulate the management message in a DOE data object, and then transmit a plurality of data words of the DOE data object, a single data word at a time, using a DOE protocol. In particular, the data words may be transmitted over a PCIe link as individual PCIe configuration write transactions.

In this way, the described techniques facilitate device management (e.g., using MCTP) over in-band PCIe without requiring additional specialized hardware. In particular, components of a system are enabled to exchange management messages without specialized hardware supporting PCI-VDM packets, thereby simplifying the hardware and reducing costs. Accordingly, systems that do not possess advanced controllers or other hardware (e.g., interposer cards) may benefit from device management capabilities. Therefore, techniques described herein enable efficient and scalable device management across various systems by utilizing existing PCIe infrastructure, eliminating the need for extensive system hardware alterations. This leads to reduced complexity in the communication protocol and enables adoption of device management in a wider range of systems.

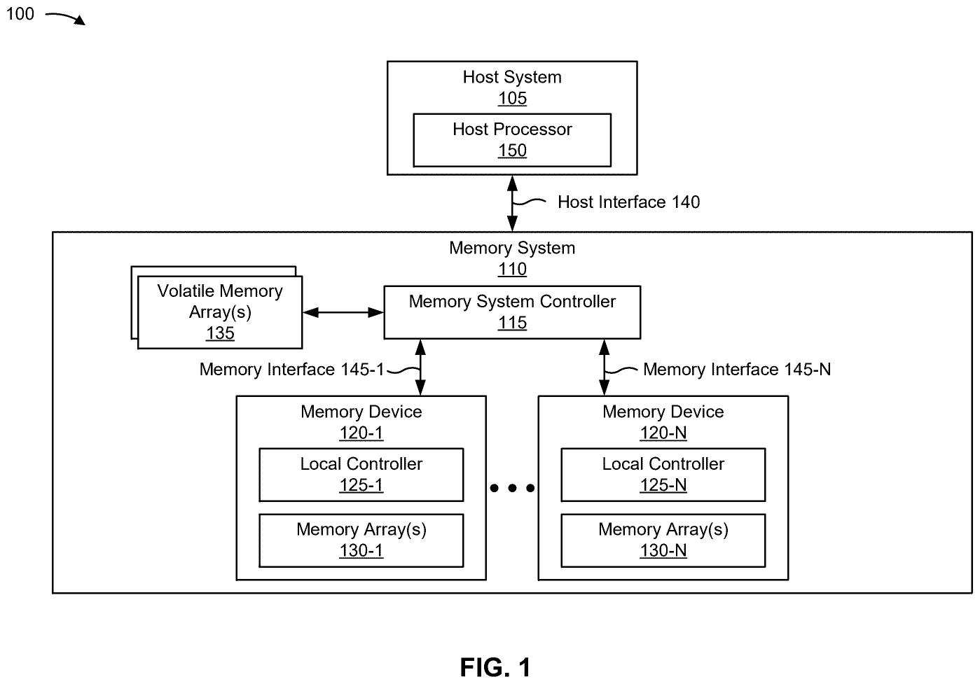

FIG. 1 is a diagram illustrating an example system 100 capable of communicating management messages encapsulated in data object exchange data objects. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

In some implementations, the host system 105 has a PCIe interface (e.g., a PCIe port, sometimes referred to as a PCIe slot) that is configured to couple directly to the host interface 140 (e.g., a PCIe bus). Similarly, the memory system 110 may have a PCIe interface (e.g., a PCIe port) that is configured to couple directly to the host interface 140 (e.g., the PCIe bus). Accordingly, a memory device 120 may be a PCIe compliant and/or compute express link (CXL) compliant memory device 120. CXL is a high-speed CPU-to-device and CPU-to-memory interconnect designed to accelerate next-generation performance. CXL technology maintains memory coherency between the CPU memory space and memory on attached devices, which allows resource sharing for higher performance, reduced software stack complexity, and lower overall system cost. CXL is designed to be an industry open standard interface for high-speed communications. CXL technology is built on the PCIe infrastructure, leveraging PCIe physical and electrical interfaces to provide advanced protocol in areas such as input/output (I/O) protocol, memory protocol, and coherency interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, the host system 105 may communicate with one or more other devices, in addition or alternatively to the memory system 110, via the host interface 140. For example, the one or more other devices may be PCIe and/or CXL compliant devices. In some examples, the one or more other devices may include a graphics card (e.g., GPU), a network interface card, a sound card, or the like.

In some implementations, one or more systems, devices, apparatuses, components, and/or controllers of FIG. 1 may be configured to receive, a single data word at a time, a plurality of first data words of a request DOE data object that encapsulates a request management message of a hardware device management protocol, where each data word of the plurality of first data words corresponds to a portion of the request management message; and transmit, a single data word at a time, a plurality of second data words of a response DOE data object that encapsulates a response management message of the hardware device management protocol, where each data word of the plurality of second data words corresponds to a portion of the response management message.

In some implementations, one or more systems, devices, apparatuses, components, and/or controllers of FIG. 1 may be configured to receive a plurality of first data words of a request DOE data object that encapsulates a request management message of a hardware device management protocol, where each data word of the plurality of first data words corresponds to a portion of the request management message; construct the request management message using the plurality of first data words; and transmit a plurality of second data words of a response DOE data object that encapsulates a response management message of the hardware device management protocol, where each data word of the plurality of second data words corresponds to a portion of the response management message.

In some implementations, one or more systems, devices, apparatuses, components, and/or controllers of FIG. 1 may be configured to transmit, a single data word at a time, a plurality of first data words of a request DOE data object that encapsulates a request management message of a hardware device management protocol, where each data word of the plurality of first data words corresponds to a portion of the request management message, and/or may be configured to receive the plurality of first data words, construct the request management message using the plurality of first data words, and transmit, a single data word at a time, a plurality of second data words of a response DOE data object that encapsulates a response management message of the hardware device management protocol, where each data word of the plurality of second data words corresponds to a portion of the response management message.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

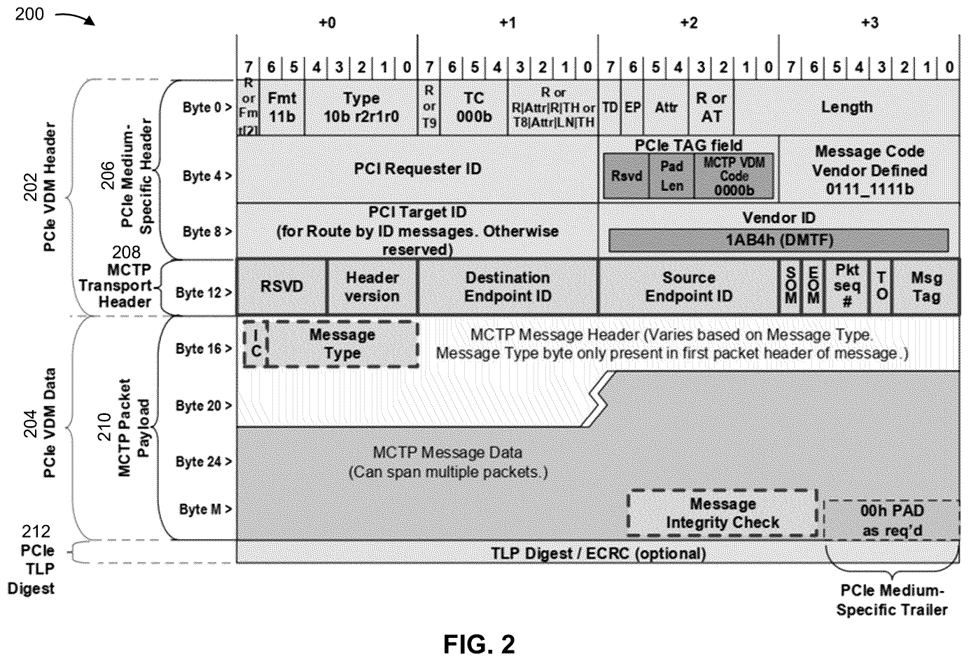

FIG. 2 is a diagram illustrating an example PCI-VDM packet 200. For example, in PCIe, a vendor may define its own message types for communication over a PCIe interface. The PCI-VDM packet 200 may carry an MCTP packet (e.g., the MCTP packet may be sent as a payload of the PCI-VDM packet 200). MCTP is a communication protocol that facilitates management and monitoring of hardware components and enables remote management capabilities. Accordingly, the MCTP packet may be or may carry a management message (e.g., from the host system 105 to a device, or from a device to the host system 105).

As shown, the PCI-VDM packet 200 has a PCIe VDM header 202 and PCIe VDM data 204. The PCIe VDM header 202 includes a PCIe medium-specific header 206, which facilitates routing and delivery within a PCIe network. The PCIe medium-specific header 206 includes fields such as a format (Fmt) field, a type field, a traffic class (TC) field, and other fields that provide information on packet formation and the nature of the data being communicated. Furthermore, the PCIe medium-specific header 206 may indicate information that enables the transmission of non-standard messages within a PCIe environment, such as a PCI requester identifier, a tag field that aids in matching requests with responses, and a message code that may indicate that the packet carries a VDM payload. The PCIe VDM header 202 may include an MCTP transport header 208 that indicates a destination endpoint identifier and a source endpoint identifier.

The core MCTP packet header and data may be nested within the PCIe VDM structure. For example, the PCIe VDM data 204 may include an MCTP packet payload 210 that indicates an MCTP message type (e.g., present only in the first packet header) and an MCTP message header (e.g., that may vary based on the MCTP message type). This information is followed by the actual data conveyed in the MCTP message, which can span multiple packets. The end of the packet structure may include a PCIe transport layer packet (TLP) digest 212. As described herein, the PCI-VDM packet 200 can be communicated over in-band PCIe, which may involve the use of an additional PCIe interposer card for a device that does not natively support MCTP packets over in-band PCIe. “In-band PCIe” may refer to a PCIe physical layer within a PCIe interface, whereas “out-of-band PCIe” may refer to a physical layer associated with one or more non-PCIe protocols within the PCIe interface.

As indicated above, FIG. 2 is provided as an example. Other examples may differ from what is described with regard to FIG. 2.

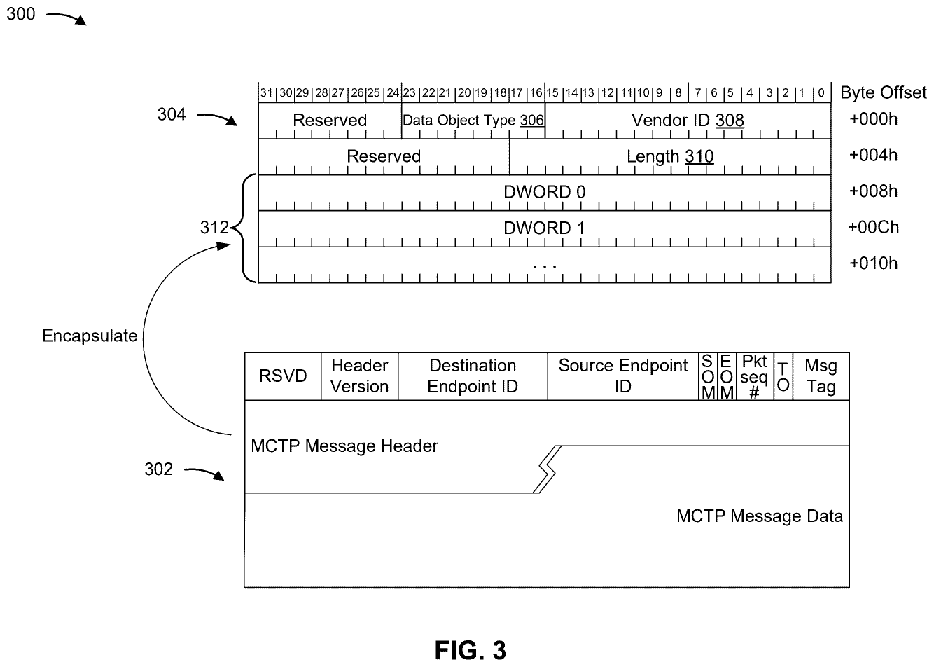

FIG. 3 is a diagram illustrating an example 300 of encapsulating a management message 302, shown as an MCTP packet (e.g., that includes MCTP transport header 208 and MCTP packet payload 210), in a DOE data object 304. As shown, the DOE data object 304 may include a data object type field 306, a vendor identifier (ID) field 308, a length field 310, and one or more data object data words 312 (shown as DWORD 0, DWORD 1, etc.).

The data object type field 306 and/or the vendor ID field 308 may include values indicating that the DOE data object 304 encapsulates the management message 302 (e.g., indicating that the DOE data object 304 is being used for management message communication). In some examples, a new vendor identifier and/or one or more new vendor-defined data object types may be used to identify DOE data objects that carry management messages. For example, the data object type field 306 may indicate a first vendor-defined DOE data object type used for synchronous management messages (e.g., used for synchronous MCTP requests and responses). In particular, the first vendor-defined DOE data object type (e.g., for MCTP requests and responses) may be used for MCTP packets over DOE when the first vendor-defined DOE data object type is supported by a specific DOE instance on a device. The first vendor-defined DOE data object type may be permitted to include DOE discovery response data object contents. As another example, the data object type field 306 may indicate a second vendor-defined DOE data object type used for asynchronous management messages (e.g., asynchronous MCTP messages sent from a device to a host device).

Asynchronous management messages may be sent from the device to the host device without prior solicitations. In particular, the second vendor-defined DOE data object type (e.g., for MCTP asynchronous messages) may be used for MCTP messages generated asynchronously by a device (e.g., an MCTP endpoint) on a specific DOE instance. The second vendor-defined DOE data object type may be required to include DOE discovery response data object contents.

The management message 302 may be deconstructed into the data words 312 (e.g., data units) of the DOE data object 304, starting at DWORD 0. For example, a host device (e.g., host processor 150) may send, to a device (e.g., a device of memory system 110 and/or another PCIe or CXL compliant device), a management message 302 (e.g., an MCTP request) packed in a DOE data object 304. Similarly, the device may send, to the host device, a management message 302 (e.g., an MCTP response) packed in a DOE data object 304. In these examples, data object type fields 306 of the DOE data objects 304 may indicate the vendor-defined DOE data object type used for synchronous management messages. DOE data objects 304 may be exchanged between the host device and the device using PCIe configuration read and write messages. In this way, PCI DOE mailbox writes and reads between the host device (e.g., executing software) and the device (e.g., executing firmware) can be used for management message (e.g., MCTP message) requests and responses. In some implementations, a maximum DOE data object size may be 256 kilobyte data words, which may correspond to a maximum management message (e.g., MCTP packet) size (minus two data words for the data object header). A size of the DOE data object 304 may be dictated by a size of the underlying management message 302.

In some implementations, the device may transmit an asynchronous message to the host device using an asynchronous DOE message that identifies (e.g., using the data object type field 306) the vendor-defined DOE data object type used for asynchronous management messages. For example, asynchronous management messages (e.g., MCTP interrupts) may use the message signaled interrupts extended (MSI-X) mechanism defined in the DOE protocol. The use of MSI-X may be indicated via a DOE interrupt support bit in DOE capabilities register. In some implementations, a DOE interrupt enable bit may be indicated as enabled (e.g., set to “1”) by default in order to support MCTP interrupts in DOE interrupts.

As indicated above, FIG. 3 is provided as an example. Other examples may differ from what is described with regard to FIG. 3.

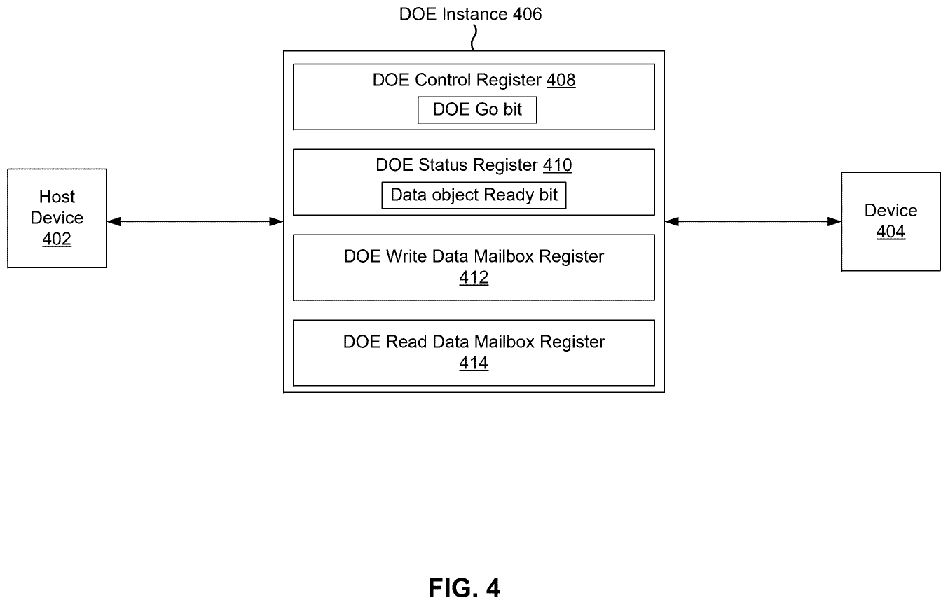

FIG. 4 is a diagram illustrating an example 400 of communicating management messages encapsulated in DOE data objects. As shown, example 400 includes a host device 402 and a device 404. The host device 402 may correspond to or may include host processor 150. The device 404 may be a PCIe device or a CXL device. For example, the device 404 may correspond to or may include memory system 110 or a device of memory system 110 (e.g., memory system controller 115 and/or a local controller 125). In some implementations, the device 404 may be another type of PCIe or CXL compliant device, such as a graphics card, a network interface card, a sound card, or the like. The host device 402 and the device 404 may be connected via a PCIe link (e.g., a physical PCIe connector). In some implementations, the device 404 may lack native support for management messages of a hardware device management protocol (e.g., MCTP messages) over in-band PCIe packets. In some implementations, the device 404 may be free of a connection to a PCIe interposer card (e.g., that would otherwise be used to communicate in-band PCIe packets).

The host device 402 and the device 404 may communicate management messages of a hardware device management protocol (e.g., MCTP messages) by encapsulating the management messages in DOE data objects, as described in connection with FIG. 3. In some implementations, the host device 402 may implement a DOE instance 406 to facilitate the communication of DOE data objects between the host device 402 and the device 404. For example, the DOE instance 406 may enable communication between software of the host device 402 and firmware of the device 404. In some implementations, the DOE instance 406 may include a DOE control register 408, a DOE status register 410, a DOE write mailbox register 412, and a DOE read mailbox register 414. These registers may be memory mapped. The DOE control register 408 may include a DOE go bit, which may be used to indicate that the host device 402 has completed a request management message transmission to the device 404. The DOE status register 410 may include a DOE ready bit, which may be used to indicate that the device 404 has a response management message transmission for the host device 402. In some implementations, the DOE instance 406 may be a dedicated DOE instance for management messages (e.g., MCTP messages) to avoid any conflicts with other protocols. In this way, the use of a connection identifier for MCTP data object features may not be required.

The mailbox registers 412, 414 facilitate PCIe configuration space transactions between the host device 402 and the device 404. These transactions may be conveyed in accordance with the PCIe protocol using configuration write messages and/or configuration read messages embedded in PCIe transaction layer packets (TLPs). Thus, techniques described herein enable device management that is integrated with PCIe functionality, thereby simplifying device management, and improving compatibility across different system architectures.

In some implementations, the host device 402 may perform a DOE discovery sequence to discover the data object types that are supported by the DOE instance 406. For example, the supported data object types may include the first vendor-defined DOE data object type used for synchronous management messages, and the second vendor-defined DOE data object type used for asynchronous management messages. At a completion of the DOE discovery sequence, the host device 402 (e.g., using a management service, such as an MCTP service) may initiate a management discovery sequence (e.g., an MCTP discovery sequence) using management messages in DOE data objects over the DOE instance 406, as described herein. In some implementations, the host device 402 and/or the device 404 may determine (e.g., check) whether a DOE busy bit of the DOE instance 406 is clear. The DOE busy bit being clear may indicate that the DOE instance 406 is ready to receive management messages in DOE data objects.

As indicated above, FIG. 4 is provided as an example. Other examples may differ from what is described with regard to FIG. 4.

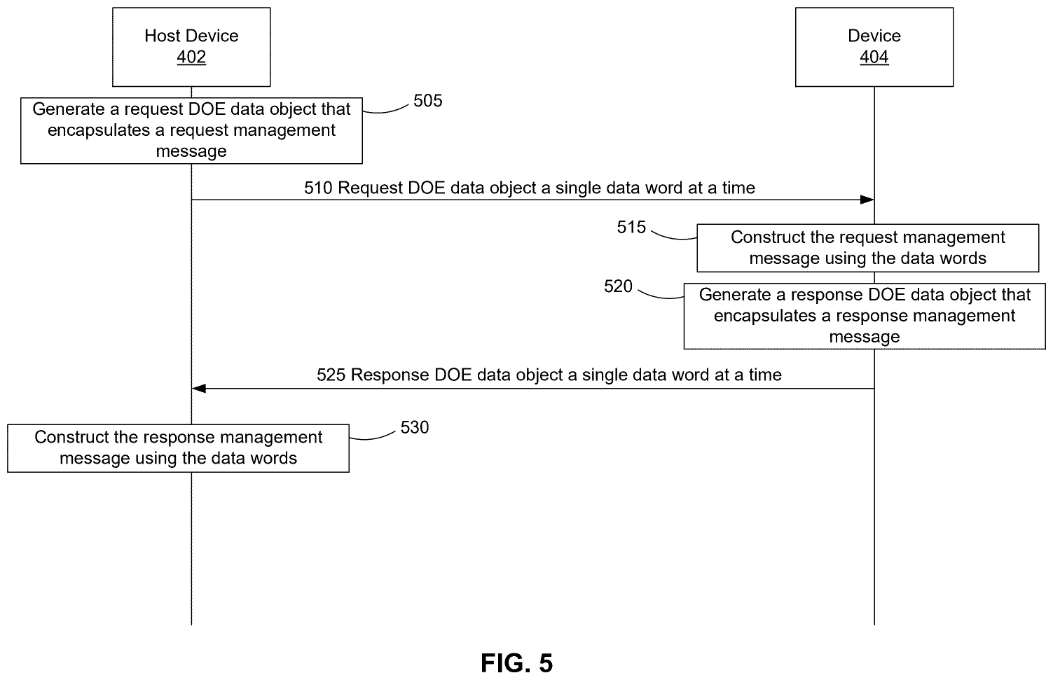

FIG. 5 is a diagram illustrating an example 500 of communicating management messages encapsulated in DOE data objects. As shown, example 500 includes the host device 402 and the device 404 described in connection with FIG. 4.

As shown by reference number 505, the host device 402 may generate a request DOE data object that encapsulates a request management message of a hardware device management protocol (e.g., an MCTP packet). For example, the host device 402 may generate the request management message, and then generate the request DOE data object to encapsulate the request management message, as described in connection with FIG. 3. The request management message may include one or more management commands for device or firmware management (e.g., a device management command or a firmware update command), which may facilitate firmware updating, retrieval of device data, and/or obtaining current values from device-associated sensors. The request DOE data object may indicate the vendor-defined DOE data object type used for synchronous management messages, may indicate a vendor identifier, and may indicate a length corresponding to a length of the request management message (e.g., a length of the MCTP packet). The request management message may be deconstructed (e.g., converted) into a plurality of data words of the request DOE data object (e.g., starting from DWORD 0), thereby providing encapsulation of the request management message in the request DOE data object. Accordingly, each data word may correspond to a portion of the request management message. For example, the data words may represent both a header and a payload of an MCTP packet.

As shown by reference number 510, the host device 402 may transmit, and the device 404 may receive (e.g., over a PCIe link), the request data object a single data word at a time. For example, the host device 402 may transmit, and the device 404 may receive, a single data word at a time, a plurality of data words of the request DOE data object. One or more initial data words may indicate the data object type, the vendor identifier, and the length, followed by data words corresponding to the response management message.

In connection with transmitting the data words, the host device 402 may write the data words of the request DOE data object, a data word at a time, to the DOE write data mailbox register 412, thereby causing transmission of the data words as the data words are written to the DOE write data mailbox register 412. For example, writing each data word to the DOE write data mailbox register 412 may cause (e.g., trigger) transmission of a packet (e.g., via the DOE instance 406) to the device 404. Thus, the device 404 may receive the data words in a plurality of packets (e.g., a plurality of configuration write TLPs), where each packet contains a respective data word. The device 404 may read the data words as the device 404 receives the packets. When the host device 402 has completed writing the entire request DOE data object, the host device 402 may set the DOE go bit in the DOE control register 408 (e.g., to a value of “1”) to indicate a completion of transmission of the data words.

The device 404 may read the DOE go bit (e.g., setting the DOE go bit may trigger transmission of a TLP to the device 404). Responsive to the DOE go bit being set, as shown by reference number 515, the device 404 may construct (e.g., consume) the request management message (e.g., via the DOE instance 406) using the data words. The device 404 may perform one or more actions as requested in the request management message.

As shown by reference number 520, the device 404 may generate a response DOE data object that encapsulates a response management message of the hardware device management protocol (e.g., an MCTP packet). For example, the device 404 may generate the response management message, and then generate the response DOE data object to encapsulate the response management message, as described in connection with FIG. 3. The response management message may include sensor data, a device status, a firmware update status, or the like. Similarly to the request DOE data object, the response DOE data object may indicate the vendor-defined DOE data object type used for synchronous management messages, may indicate a vendor identifier, and may indicate a length corresponding to a length of the management message (e.g., a length of the MCTP packet). Similarly to the request management message, the response management message may be deconstructed (e.g., converted) into a plurality of data words of the response DOE data object (e.g., starting from DWORD 0), thereby providing encapsulation of the response management message in the response DOE data object. Accordingly, each data word may correspond to a portion of the response management message. For example, the data words may represent both a header and a payload of an MCTP packet.

To indicate that the device 404 has data ready for the host device 402 (e.g., to indicate that the DOE instance 406 has data to be read), the device 404 may set the data object ready bit in the DOE status register 410 (e.g., a DOE software notification). As shown by reference number 525, the device 404 may transmit, and the host device 402 may receive (e.g., over a PCIe link), the response data object a single data word at a time. For example, the device 404 may transmit, and the host device 402 may receive, a single data word at a time, a plurality of data words of the response DOE data object. One or more initial data words may indicate the data object type, the vendor identifier, and the length, followed by data words corresponding to the response management message. After the device 404 has transmitted the final data word of the response DOE data object, the device 404 may clear the data object ready bit in the DOE status register 410 (e.g., to clear a DOE busy status associated with the device 404).

The device 404 may transmit the data words to cause the data words to be written to the DOE read data mailbox register 414. For example, the device 404 may transmit the data words in a plurality of packets (e.g., a plurality of configuration write TLPs), where each packet contains a respective data word. Thus, the device 404 may transmit each packet to cause a data word to be written to the DOE read data mailbox register 414. The host device 402 may read each data word from the DOE read data mailbox register 414 a single data word at a time. After reading a data word, the host device 402 may read (e.g., check) the data object ready bit in the DOE status register 410, and if the data object ready bit is set (e.g., indicating that the device 404 has more data to send), the host device 402 may write a value (e.g., any value) to the DOE read data mailbox register 414 to indicate that the data word was read from the DOE read data mailbox register 414 and to request the next data word be written to the DOE read data mailbox register 414.

Writing of the value to the DOE read data mailbox register 414 may cause transmission (e.g., via the DOE instance 406) of a packet (e.g., a TLP) to the device 404 that indicates the value. Accordingly, the device 404 may receive the value written to the DOE read data mailbox register 414. Responsive to reception of the value, the device 404 may transmit a next data word (e.g., in a packet) to cause the next data word to be written to the DOE read data mailbox register 414, and so forth.

Responsive to the data object ready bit being cleared, as shown by reference number 530, the host device 402 may construct (e.g., consume) the response management message (e.g., via the DOE instance 406) using the data words. The host device 402 may perform one or more actions based on the response management message.

By leveraging the ability of the host device 402 and the device 404 to encapsulate management messages as data objects in a format recognizable by PCIe and/or CXL devices, management messages can be exchanged between the host device 402 and the device 404 using in-band PCIe communication, thereby eliminating the need for specialized interfacing hardware or intelligent root ports that otherwise would be used to facilitate management communication over PCIe. Accordingly, techniques described herein improve interoperability between the host device 402 and the device 404, and facilitate widespread usage of device management operations according to a simple and cost-effective framework.

As indicated above, FIG. 5 is provided as an example. Other examples may differ from what is described with regard to FIG. 5.

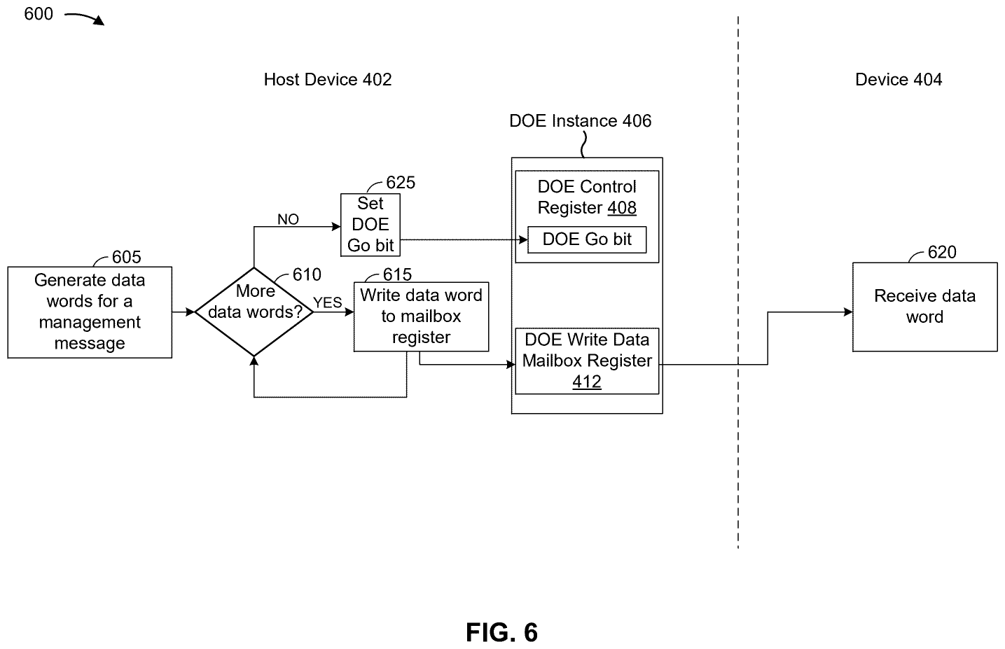

FIG. 6 is a diagram of an example 600 of communicating management messages encapsulated in DOE data objects. Example 600 includes the host device 402, the device 404, and the DOE instance 406 described in connection with FIG. 4.

As shown in FIG. 6, the host device 402 may generate data words for a request management message of a hardware device management protocol (block 605). For example, at block 605 the host device 402 (e.g., software executing on the host device 402) may be ready to write data words (e.g., representing a request DOE data object encapsulating a request management message, such as an MCTP packet) to the DOE instance 406. If the host device 402 has a remaining data word to transmit (block 610—YES), the host device 402 may write the data word to the DOE write data mailbox register 412 (block 615). This writing causes a configuration write message TLP, containing the data word, to be sent to the device 404 (e.g., via the DOE instance 406). As further shown in FIG. 6, the device 404 may receive the data words (e.g., in respective configuration write message TLPs) as the data words are written to the DOE write data mailbox register 412. For example, the device 404 may consume the request DOE data object as configuration write message TLPs arrive at the device 404 (e.g., the DOE instance 406 may consume the request DOE data object from the DOE write data mailbox register 412). The host device 402 may perform the operation of block 615, and the device 404 may perform the operation of block 620, one or more times until all data words of the request DOE data object have been sent to the device 404. Thus, once the host device 402 has no more remaining data words to transmit (block 610—NO), the host device 402 may set the DOE go bit in the DOE control register 408 to indicate completion of the transmission of the request DOE data object (block 625).

As indicated above, FIG. 6 is provided as an example. Other examples may differ from what is described with regard to FIG. 6.

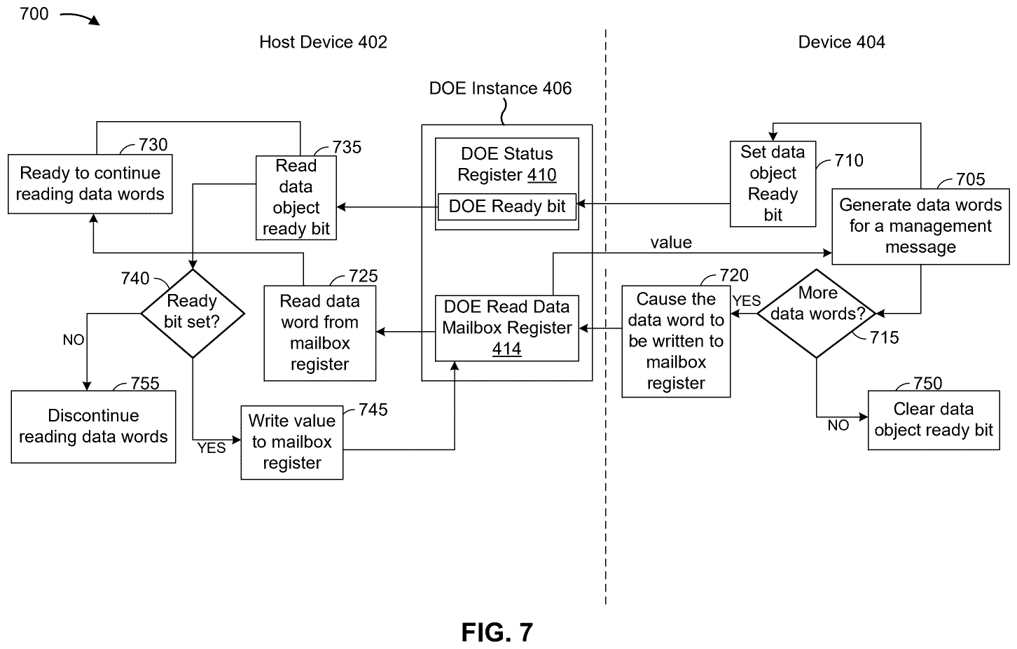

FIG. 7 is a diagram of an example 700 of communicating management messages encapsulated in DOE data objects. Example 700 includes the host device 402, the device 404, and the DOE instance 406 described in connection with FIG. 4.

As shown in FIG. 7, the device 404 may generate data words for a response management message of a hardware device management protocol (block 705). For example, at block 705 the device 404 (e.g., firmware executing on the device 404) may be ready to write data words (e.g., representing a response DOE data object encapsulating a response management message, such as an MCTP packet) to the DOE instance 406. Based on having data words to write to the DOE instance 406, the device 404 may set the data object ready bit in the DOE status register 410 to indicate that the device 404 has data words to write (block 710). If the device 404 has a remaining data word to transmit (block 715—YES), the device 404 may cause the data word to be written to the DOE read data mailbox register 414 (block 720). For example, the device 404 may transmit (e.g., via the DOE instance 406) a configuration write message TLP, containing the data word, that causes the data word to be written to the DOE read data mailbox register 414.

As further shown in FIG. 7, the host device 402 may read the data word from the DOE read data mailbox register 414 (block 725). Once the host device 402 is ready to continue reading data words (block 730) (e.g., software executing on the host device 402 is ready to read data words from the DOE instance 406), the host device 402 may read (e.g., check) the data object ready bit in the DOE status register 410 (block 735). If the data object ready bit is set (block 740—YES), thereby indicating that the device 404 has additional data words to write, the host device 402 may write a value (e.g., any value) to the DOE read data mailbox register 414 to indicate that the next data word can be written to the DOE read data mailbox register 414 (block 745). The device 404 may receive the value indicating that the next data word can be written to the DOE read data mailbox register 414 (e.g., as a configuration write message TLP, via the DOE instance 406).

The device 404 may perform the operation of block 720, and the host device 402 may perform the operations of blocks 725 through 745, one or more times until all data words of the response DOE data object have been sent to the host device 402. Thus, once the device 404 has no more remaining data words to transmit (block 715—NO), the device 404 may stop transmission of the response DOE data object and clear the data object ready bit in the DOE status register 410 to indicate completion of the transmission of the response DOE data object (block 750). After reading the final data word (at block 725) and reading the data object ready bit in the DOE status register 410 (at block 735), the host device 402 may identify that the data object ready bit in the DOE status register 410 is not set (block 740—NO) and the host device 402 (e.g., software executing on the host device 402) may discontinue reading data words from the DOE read data mailbox register 414 (block 755).

As indicated above, FIG. 7 is provided as an example. Other examples may differ from what is described with regard to FIG. 7.

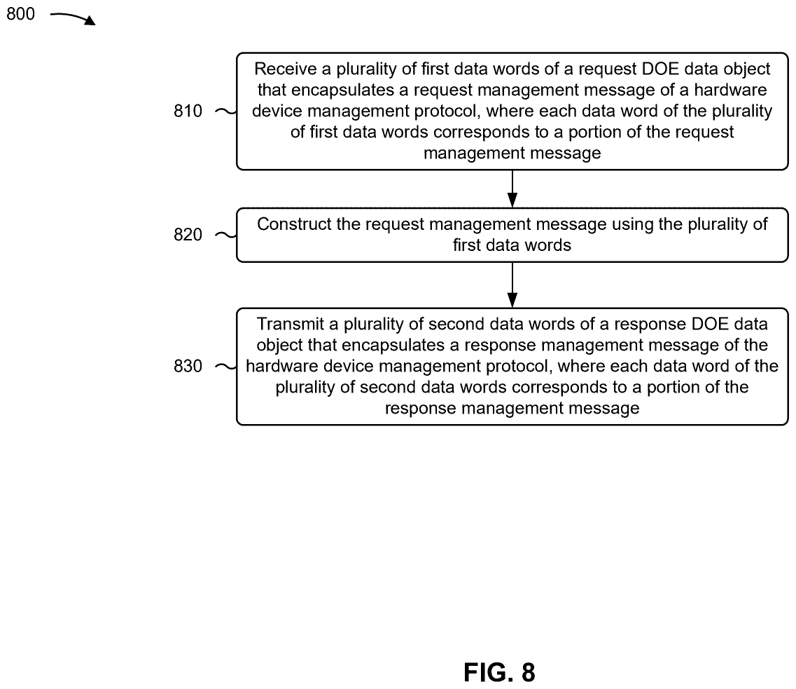

FIG. 8 is a flowchart of an example method 800 associated with communicating management messages encapsulated in DOE data objects. In some implementations, a device (e.g., the device 404) may perform or may be configured to perform the method 800. In some implementations, another device or a group of devices separate from or including the device (e.g., host device 402) may perform or may be configured to perform the method 800. Additionally, or alternatively, one or more components of the device (e.g., memory system controller 115 and/or a local controller 125) may perform or may be configured to perform the method 800. Thus, means for performing the method 800 may include the device and/or one or more components of the device. Additionally, or alternatively, a non-transitory computer-readable medium may store one or more instructions that, when executed by the device, cause the device to perform the method 800.

As shown in FIG. 8, the method 800 may include receiving a plurality of first data words of a request DOE data object that encapsulates a request management message of a hardware device management protocol, where each data word of the plurality of first data words corresponds to a portion of the request management message (block 810). As further shown in FIG. 8, the method 800 may include constructing the request management message using the plurality of first data words (block 820). As further shown in FIG. 8, the method 800 may include transmitting a plurality of second data words of a response DOE data object that encapsulates a response management message of the hardware device management protocol, where each data word of the plurality of second data words corresponds to a portion of the response management message (block 830).

The method 800 may include additional aspects, such as any single aspect or any combination of aspects described below and/or described in connection with one or more other methods or operations described elsewhere herein.

In a first aspect, receiving the plurality of first data words includes receiving a plurality of packets, where each packet of the plurality of packets contains a respective data word of the plurality of first data words.

In a second aspect, alone or in combination with the first aspect, transmitting the plurality of second data words includes transmitting a plurality of packets, where each packet of the plurality of packets contains a respective data word of the plurality of second data words.

In a third aspect, alone or in combination with one or more of the first and second aspects, transmitting the plurality of second data words includes setting a data object ready bit in a DOE status register to indicate that a DOE read mailbox register is to include data, transmitting a data word of the plurality of second data words to cause the data word to be written to the DOE read data mailbox register, receiving a value written to the DOE read data mailbox register after writing of the data word to the DOE read data mailbox register, where the value written to the DOE read data mailbox register indicates that the data word was read from the DOE read data mailbox register, and transmitting, responsive to reception of the value, a next data word of the plurality of second data words to cause the next data word to be written to the DOE read data mailbox register.

In a fourth aspect, alone or in combination with one or more of the first through third aspects, the request DOE data object or the response DOE data object indicates a vendor-defined DOE data object type used for synchronous management messages.

In a fifth aspect, alone or in combination with one or more of the first through fourth aspects, the method 800 includes transmitting an asynchronous DOE message that identifies a vendor-defined DOE data object type used for asynchronous management messages.

In a sixth aspect, alone or in combination with one or more of the first through fifth aspects, the request management message includes at least one of a device management command, or a firmware update command.

In a seventh aspect, alone or in combination with one or more of the first through sixth aspects, the response management message includes at least one of sensor data, a device status, or a firmware update status.

In an eighth aspect, alone or in combination with one or more of the first through seventh aspects, the plurality of first data words, or the plurality of second data words, represent a header and a payload of an MCTP packet.

In a ninth aspect, alone or in combination with one or more of the first through eighth aspects, communications between the device and the host device use a dedicated DOE instance for management messages.

Although FIG. 8 shows example blocks of a method 800, in some implementations, the method 800 may include additional blocks, fewer blocks, different blocks, or differently arranged blocks than those depicted in FIG. 8. Additionally, or alternatively, two or more of the blocks of the method 800 may be performed in parallel. The method 800 is an example of one method that may be performed by one or more devices described herein. These one or more devices may perform or may be configured to perform one or more other methods based on operations described herein.

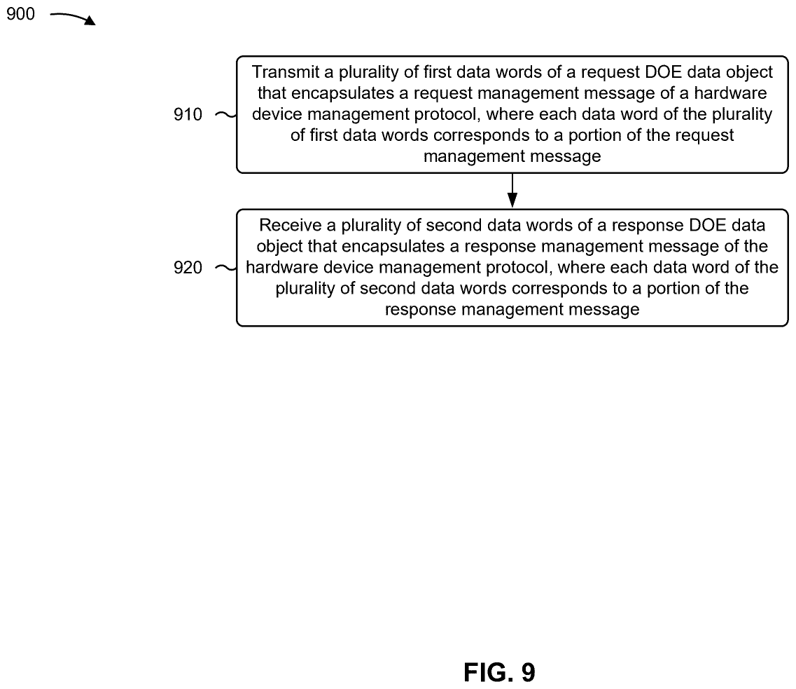

FIG. 9 is a flowchart of an example method 900 associated with communicating management messages encapsulated in DOE data objects. In some implementations, a host device (e.g., the host device 402) may perform or may be configured to perform the method 900. In some implementations, another device or a group of devices separate from or including the host device (e.g., device 404) may perform or may be configured to perform the method 900. Additionally, or alternatively, one or more components of the host device (e.g., host processor 150) may perform or may be configured to perform the method 900. Thus, means for performing the method 900 may include the host device and/or one or more components of the host device. Additionally, or alternatively, a non-transitory computer-readable medium may store one or more instructions that, when executed by the host device, cause the host device to perform the method 900.

As shown in FIG. 9, the method 900 may include transmitting a plurality of first data words of a request DOE data object that encapsulates a request management message of a hardware device management protocol, where each data word of the plurality of first data words corresponds to a portion of the request management message (block 910). As further shown in FIG. 9, the method 900 may include receiving a plurality of second data words of a response DOE data object that encapsulates a response management message of the hardware device management protocol, where each data word of the plurality of second data words corresponds to a portion of the response management message (block 920).

The method 900 may include additional aspects, such as any single aspect or any combination of aspects described below and/or described in connection with one or more other methods or operations described elsewhere herein.

In a first aspect, transmitting the plurality of first data words includes transmitting a plurality of packets, where each packet of the plurality of packets contains a respective data word of the plurality of first data words.

In a second aspect, alone or in combination with the first aspect, receiving the plurality of second data words includes receiving a plurality of packets, where each packet of the plurality of packets contains a respective data word of the plurality of second data words.

In a third aspect, alone or in combination with one or more of the first and second aspects, the request DOE data object or the response DOE data object indicates a vendor-defined DOE data object type used for synchronous management messages.

In a fourth aspect, alone or in combination with one or more of the first through third aspects, the method 900 includes receiving an asynchronous DOE message that identifies a vendor-defined DOE data object type used for asynchronous management messages.

In a fifth aspect, alone or in combination with one or more of the first through fourth aspects, the request management message includes at least one of a device management command, or a firmware update command.

In a sixth aspect, alone or in combination with one or more of the first through fifth aspects, the response management message includes at least one of sensor data, a device status, or a firmware update status.

In a seventh aspect, alone or in combination with one or more of the first through sixth aspects, the plurality of first data words, or the plurality of second data words, represent a header and a payload of an MCTP packet.

In an eighth aspect, alone or in combination with one or more of the first through seventh aspects, communications between the device and the host device use a dedicated DOE instance for management messages.

Although FIG. 9 shows example blocks of a method 900, in some implementations, the method 900 may include additional blocks, fewer blocks, different blocks, or differently arranged blocks than those depicted in FIG. 9. Additionally, or alternatively, two or more of the blocks of the method 900 may be performed in parallel. The method 900 is an example of one method that may be performed by one or more devices described herein. These one or more devices may perform or may be configured to perform one or more other methods based on operations described herein.

In some implementations, a device includes one or more components configured to: receive, a single data word at a time, a plurality of first data words of a request DOE data object that encapsulates a request management message of a hardware device management protocol, wherein each data word of the plurality of first data words corresponds to a portion of the request management message; and transmit, a single data word at a time, a plurality of second data words of a response DOE data object that encapsulates a response management message of the hardware device management protocol, wherein each data word of the plurality of second data words corresponds to a portion of the response management message.

In some implementations, a method includes receiving, by a device and from a host device, a plurality of first data words of a request DOE data object that encapsulates a request management message of a hardware device management protocol, wherein each data word of the plurality of first data words corresponds to a portion of the request management message; constructing, by the device, the request management message using the plurality of first data words; and transmitting, by the device to the host device, a plurality of second data words of a response DOE data object that encapsulates a response management message of the hardware device management protocol, wherein each data word of the plurality of second data words corresponds to a portion of the response management message.

In some implementations, a system includes a host device configured to: transmit, a single data word at a time, a plurality of first data words of a request DOE data object that encapsulates a request management message of a hardware device management protocol, wherein each data word of the plurality of first data words corresponds to a portion of the request management message; and a device configured to: receive the plurality of first data words; construct the request management message using the plurality of first data words; and transmit, a single data word at a time, a plurality of second data words of a response DOE data object that encapsulates a response management message of the hardware device management protocol, wherein each data word of the plurality of second data words corresponds to a portion of the response management message.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device, comprising:
one or more components configured to:
receive, a single data word at a time, a plurality of first data words of a request data object exchange (DOE) data object that encapsulates a request management message of a hardware device management protocol,
wherein each data word of the plurality of first data words corresponds to a portion of the request management message; and
transmit, a single data word at a time, a plurality of second data words of a response DOE data object that encapsulates a response management message of the hardware device management protocol,
wherein each data word of the plurality of second data words corresponds to a portion of the response management message.

2. The device of claim 1, wherein the one or more components, to receive the plurality of first data words, are configured to:
receive a plurality of packets,
wherein each packet of the plurality of packets contains a respective data word of the plurality of first data words.

3. The device of claim 2, wherein the one or more components, to receive the plurality of packets, are configured to:
receive each packet of the plurality of packets responsive to the respective data word being written to a DOE write data mailbox register.

4. The device of claim 1, wherein the one or more components, to transmit the plurality of second data words, are configured to:
transmit a plurality of packets,
wherein each packet of the plurality of packets contains a respective data word of the plurality of second data words.

5. The device of claim 4, wherein the one or more components, to transmit the plurality of packets, are configured to:
transmit each packet of the plurality of packets to cause the respective data word to be written to a DOE read data mailbox register.

6. The device of claim 1, wherein the one or more components, to transmit the plurality of second data words, are configured to:
set a data object ready bit in a DOE status register;
transmit a data word of the plurality of second data words to cause the data word to be written to the DOE read data mailbox register;
receive a value written to the DOE read data mailbox register after writing of the data word to the DOE read data mailbox register,
wherein the value written to the DOE read data mailbox register indicates that the data word was read from the DOE read data mailbox register; and
transmit, responsive to reception of the value, a next data word of the plurality of second data words to cause the next data word to be written to the DOE read data mailbox register.

7. The device of claim 1, wherein the one or more components, to receive the plurality of first data words and to transmit the plurality of second data words, are configured to:
receive the plurality of first data words and transmit the plurality of second data words over a peripheral component interconnect express (PCIe) link.

8. The device of claim 1, wherein the request management message or the response management message is a management component transport protocol (MCTP) packet.

9. The device of claim 1, wherein the device is a peripheral component interconnect express (PCIe) device or a compute express link (CXL) device.

10. The device of claim 1, wherein the device lacks native support for the request management message or the response management message over in-band peripheral component interconnect express (PCIe) packets.

11. A method, comprising:
receiving, by a device and from a host device, a plurality of first data words of a request data object exchange (DOE) data object that encapsulates a request management message of a hardware device management protocol,
wherein each data word of the plurality of first data words corresponds to a portion of the request management message;
constructing, by the device, the request management message using the plurality of first data words; and
transmitting, by the device to the host device, a plurality of second data words of a response DOE data object that encapsulates a response management message of the hardware device management protocol,
wherein each data word of the plurality of second data words corresponds to a portion of the response management message.

12. The method of claim 11, wherein receiving the plurality of first data words comprises:
receiving a plurality of packets,
wherein each packet of the plurality of packets contains a respective data word of the plurality of first data words.

13. The method of claim 11, wherein transmitting the plurality of second data words comprises:
transmitting a plurality of packets,
wherein each packet of the plurality of packets contains a respective data word of the plurality of second data words.

14. The method of claim 11, wherein transmitting the plurality of second data words comprises:
setting a data object ready bit in a DOE status register to indicate that a DOE read mailbox register is to include data;
transmitting a data word of the plurality of second data words to cause the data word to be written to the DOE read data mailbox register;
receiving a value written to the DOE read data mailbox register after writing of the data word to the DOE read data mailbox register,
wherein the value written to the DOE read data mailbox register indicates that the data word was read from the DOE read data mailbox register; and
transmitting, responsive to reception of the value, a next data word of the plurality of second data words to cause the next data word to be written to the DOE read data mailbox register.

15. The method of claim 11, wherein the request DOE data object or the response DOE data object indicates a vendor-defined DOE data object type used for synchronous management messages.

16. The method of claim 11, further comprising:
transmitting an asynchronous DOE message that identifies a vendor-defined DOE data object type used for asynchronous management messages.

17. The method of claim 11, wherein the request management message includes at least one of:
a device management command, or
a firmware update command.

18. The method of claim 11, wherein the response management message includes at least one of:
sensor data,
a device status, or
a firmware update status.

19. The method of claim 11, wherein the plurality of first data words, or the plurality of second data words, represent a header and a payload of a management component transport protocol (MCTP) packet.

20. The method of claim 11, wherein communications between the device and the host device use a dedicated DOE instance for management messages.

21. A system, comprising:
a host device configured to:
transmit, a single data word at a time, a plurality of first data words of a request data object exchange (DOE) data object that encapsulates a request management message of a hardware device management protocol,
wherein each data word of the plurality of first data words corresponds to a portion of the request management message; and
a device configured to:
receive the plurality of first data words;
construct the request management message using the plurality of first data words; and
transmit, a single data word at a time, a plurality of second data words of a response DOE data object that encapsulates a response management message of the hardware device management protocol,
wherein each data word of the plurality of second data words corresponds to a portion of the response management message.

22. The system of claim 21, wherein the host device is further configured to:
write the plurality of first data words, a single data word at a time, to a DOE write data mailbox register, to cause transmission of the plurality of first data words as the plurality of first data words are written to the DOE write data mailbox register.

23. The system of claim 21, wherein the host device is further configured to:
read a data word, of the plurality of second data words, from a DOE read data mailbox register; and
write a value to the DOE read data mailbox register to indicate that the data word was read from the DOE read data mailbox register.

24. The system of claim 21, wherein the host device is further configured to:
set a DOE go bit in a DOE control register to indicate a completion of transmission of the plurality of first data words.

25. The system of claim 21, wherein the device is free of a connection to a peripheral component interconnect express (PCIe) interposer card.
